(19) United States
(12) Patent Application Publication
(10) Pub. No.: US 2020/0117440 A1
(43) Pub. Date: Apr. 16, 2020

(54) HIERARCHICAL EQUIPMENT SOFTWARE UPDATE FOR AN ELECTRICAL DISTRIBUTION GRID

(71) Applicant: ELECTRICITE DE FRANCE, PARIS (FR)

(72) Inventors: Thierry LUCIDARME, CHEVREUSE (FR); Maxime GILLAUX, BOULOGNE BILLANCOURT (FR)

(21) Appl. No.: 16/617,637

(22) PCT Filed: May 17, 2018
(86) PCT No.: PCT/EP2018/062938

§ 371 Date: Nov. 27, 2019

(30) Foreign Application Priority Data
May 30, 2017 (FR) 1754764

(51) Int. Cl. G06F 8/65; G06Q 50/06

(52) U.S. Cl. CPC G06F 8/65; G06Q 50/06

(57) ABSTRACT

The disclosure relates to updating software intended to be executed by equipment of an electrical distribution grid. Each equipment unit forms a node of a command-control network communicating with other nodes of this command-control network, and the nodes of the command-control network have respective identifiers. The method provides in particular the steps implemented by a current node: obtaining first data of the identifier of the at least one secondary node for which the current node is configured for allowing a software update; and upon receiving a software update request for a secondary node, using these first data for a software update at least for the secondary node identified in these first data.

### BACKGROUND OF THE INVENTION

### Field of the Invention

The present invention relates to the command-control of equipment implemented in the context of “Smartgrid” type intelligent electrical grids.

More specifically the invention relates to a method relating to maintenance operations for this equipment and more specifically the mechanisms for software version management and update, such as in particular firmware in all or part of the distributed equipment for a grid.

### Description of the Related Art

In general, “software update” is understood to mean the fact of updating a firmware version in an equipment unit, or even simply installing software in new equipment, or again updating one or more files that such software uses. It can be a matter of updating automation functions for this equipment, or even other functions, such as telecommunication or cyber security functions.

Updating firmware and other files in an equipment command-control network for an electrical grid is done under the control of a central root node which may, for example in the context of Smartgrids, be a node called a “Smartgrid Device Management System” (labeled SDMS in the attached drawings). Among other things, this node manages the actions for updating the grid from the “operation” layer of the “Smartgrid” standard model defined by the IEC (“International Electrotechnical Commission”) standardization body. In that way, a significant quantity of data is passed through all branches of the network. This quantity of data is even larger when the equipment for which the software is to be updated is close to the root node.

Consequently, some nodes of the grid near the root node and/or the root node itself can be saturated by software update requests from equipment downstream in the network.

Additionally, today, much equipment is updated manually according to a complex ordering process.

### SUMMARY OF THE INVENTION

The present invention aims to improve this situation.

For this purpose it proposes a method implemented by computer means for updating software intended to be executed by equipment of an electrical distribution grid. Each equipment unit forms a node of a command-control network communicating with other nodes of this command-control network. The nodes of the command-control network have respective identifiers.

The method comprises in particular the steps implemented by a current node:
obtaining first data of the identifier of the at least one secondary node for which the current node is configured for allowing a software update; and
upon receiving a software update request for a secondary node, using said first data for a software update at least for the secondary node identified in said first data.

Thus, the present invention proposes a predefined hierarchy (initially as a function of the topology of the network or dynamically as a function of new hardware installations) for software updates to be done for each equipment unit of the electrical distribution grid.

Advantageously, such an implementation serves to distribute the role of the various nodes of the network for propagating these updates. Thus, it is possible to also define reference nodes of the network, which could broadcast these updates to secondary nodes.

It will then be understood that in such an implementation a current node, which this time is defined as a secondary node of such reference nodes, can implement the following steps:
getting second data comprising at least one reference node identifier from the current node; and,
for a software update of the current node:
reading said second data for identifying at least one reference node; and
preparing an update request for the software of the current node, where said request is intended for the identified reference node and comprises the identifier of the current node.

Thus, according to the general definition of the invention disclosed above, a reference node can authorize the update for one or more secondary nodes. In this specific, inverse embodiment, a secondary node can have one or more reference nodes declared in the aforementioned second data and can have it in order to resolve the same problem presented in the above introduction.

This inverse embodiment is advantageous as such and can be subject to separate protection.

Advantageously, identifiers present in the update requests can be used for authorizing, or not, a transfer of update data for a secondary node, and for this purpose the method may comprise the following steps, implemented by a current node:
upon receiving a software update request for a given node, where said request comprises the identifier of the given node;
   determining whether the identifier of the given node is included among said first data; and
   as applicable, authorizing a software update for the given node, or otherwise refusing said update.

In an embodiment, each node stores both the first and second data. With such an embodiment it can be done such that each node of the network can be autonomous both for transmission of update data to secondary nodes, and for receiving this update data from a reference node.

In one implementation, the first data comprise a list of secondary node identifiers. Thus each node can broadcast the updates to several secondary nodes.

The other way around, in one implementation, the second data comprise a list of reference node identifiers. In such an implementation, each secondary node can have several reference nodes, advantageously in order to simultaneously get different data coming from different reference nodes, or else in order to refer to another reference node in case of failure receiving data from a first reference node.

In an implementation, at least one of the lists of secondary and/or reference node identifiers is declared in the standard IEC 61850 as a multiple instantiation of Data Objects type objects. Such an implementation serves to homogenize the distribution of information from the reference nodes and secondary nodes to all the network systems and to do so in a standardized way. Additionally, the aforementioned IEC 61850 standard serves to define in particular a list of nodes and this could be done by means of the aforementioned multiple instantiation of Data Objects.

More specifically this multiple instantiation can be in the “Logical Node LIFH” logical node class, relating to the management of the software in a current node, according to this IEC 61850 standard.

In an advantageous implementation, the list of reference node identifiers can be ordered and, for a software update of a current node, this current node:
reads said second data for identifying at least one primary reference node from the ordered list;
prepares a first software update request intended for the first identified reference node; and
after a time delay, in case the update is not received, prepares another request intended for the following reference node identified on the ordered list, until receiving said update.

With such an implementation, the hierarchy of the nodes in the network can be defined more finely, and in particular the reference nodes for each node.

In an embodiment, the method may further comprise a prior step in which a management system for the nodes of the command-control network determines, for each node, one or more reference nodes and/or one or more secondary nodes, according to a predetermined topology of the command-controlled network.

Advantageously, such an implementation may be implemented by a network management system, possibly by cooperation via communication with a root node of the network.

The present invention also targets a system comprising at least:
a first equipment unit comprising a programmed computer circuit for executing the steps of the above method, as a reference node; and
a second equipment unit comprising a programmed computer circuit for executing the steps of the method, as a secondary node.

As an example such a computer circuit for one or the other of these first and second equipment units is shown in FIG. 4. Thus, in the example shown in FIG. 4, the computer circuit CT comprises a communication interface COM with the command-control network SMG connected to the processor PROC capable of executing operations corresponding to the steps of the above method. For that purpose, the processor PROC cooperates with a memory MEM storing in particular instructions for a computer program in the sense of the invention, and also data such as lists of secondary and/or reference nodes. The processor PROC is further connected to an interface INT for driving an update of the software (in particular the firmware) which a command module for the equipment CEQ executes in order to run the operation of the equipment.

The system may further comprise a management system for the nodes of the command-control network, where this system comprises a computer circuit programmed for executing in particular the prior step of determining the first and second data according to the topology of the network.

The present invention also targets a computer program comprising instructions (which could be distributed between the various aforementioned equipment and system) for implementation of the method when this program is executed by a processor.

The present invention also targets equipment for an electrical distribution grid comprising a computer circuit programmed for executing the steps of the method as a reference node.

It also targets equipment for an electrical distribution grid comprising a computer circuit programmed for executing the steps of the method, as a secondary node.

### BRIEF DESCRIPTION OF THE DRAWINGS

Other advantages and features of the invention will appear upon reading the detailed description of the embodiments presented below as nonlimiting examples and examining the attached drawings on which:

FIG. 1 schematically illustrates a system for implementing the invention;

FIG. 2 schematically illustrates the steps of a method in the meaning of the invention, according to a sample implementation;

FIG. 3 is an example sequence diagram for a software update according to the method from FIG. 2;

FIG. 4 shows very schematically an example of typical structure of equipment for implementing the invention (both as reference node, or as secondary node, or even as maintenance operations management system for the network equipment and in particular for updates of this equipment);

FIG. 5 shows schematically the system from FIG. 1 in a first, initial step of the method; and

FIG. 6 shows schematically the system from FIG. 1 in a second, current step of the method.

### DESCRIPTION OF THE PREFERRED EMBODIMENTS

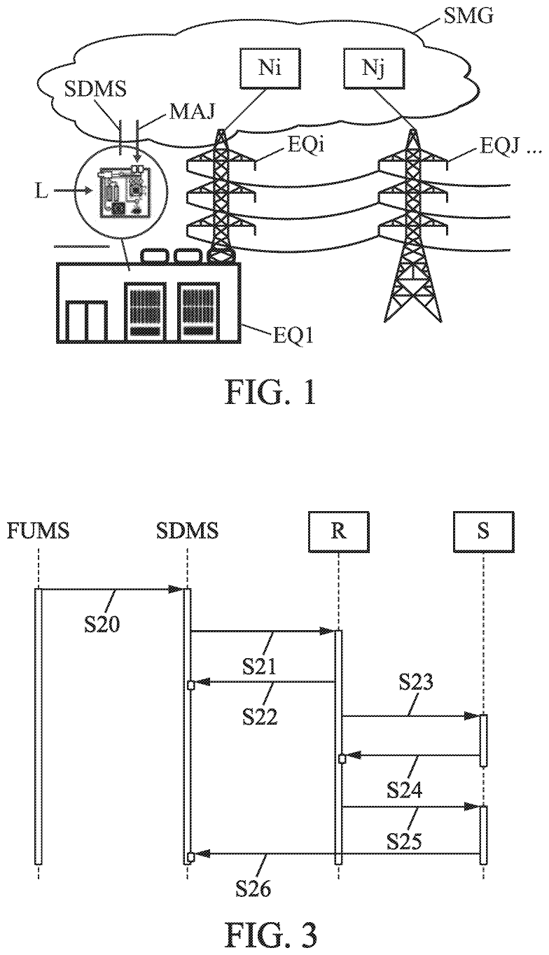

FIG. 1 shows a set of equipment EQ1, EQi, EQj for an electricity distribution grid, such as for example an HVA/LV transformer substation, one or more poles that could have routers, out to leaf nodes of the grid (not shown). This equipment is called “smart” and in particular comprises means for communication between the equipment, within a Smartgrid SMG type telecommunication network. Thus each unit of this equipment EQ1, EQi, EQj can form an SDMS node Ni, Nj, etc. of the SMG grid.

For example, the SDMS reference from FIG. 1 may designate of root central node named “Smartgrid Device Management System,” which can then receive the aforementioned lists of secondary nodes and reference nodes, and do so for each node Ni, Nj, etc. downstream on the grid. Now referring to FIG. 5 showing this situation, these lists Li(R), Li(S); Lj(R), Lj(S); etc. of reference nodes and secondary nodes are initially and/or dynamically established, for example according to a topology of the network. The system in charge of defining these lists may be, as a nonlimiting example, a FUMS (“Firmware Update Management System”) network management system in particular in charge of software updates (in particular firmware) that operate the equipment. This FUMS system may engage with the SDMS node for this purpose.

The SDMS node then sends to each node Ni a pair of lists of reference nodes Li(R) and secondary nodes Li(S), that each node can then store in memory MEM. It is appropriate to note that a leaf node completely downstream from the SMG network might have only reference nodes and the list thereof of secondary nodes might be reduced to an empty set or this node might simply not have a list of secondary nodes.

Now referring to FIG. 6, the SDMS node, upon receiving an update request for the equipment software, sends to the secondary nodes (R1, R3 in the example from FIG. 6) an update authorization for the software thereof (via the SDMS node, for example). Next, for example, the node R1 is reference for the secondary nodes S1 downstream and sends it an update authorization in turn. Similarly, a node S1 can be a reference node R2 for subsequent secondary nodes S2, and so on. It is appropriate to bring up, as shown in FIG. 6, that a secondary node (S1) can have several reference nodes R1, R3. Such an implementation can be advantageous for simultaneously downloading various parts of updates to be done, where these various parts are coming from various reference nodes R1, R3 in order to relieve the load on each reference node.

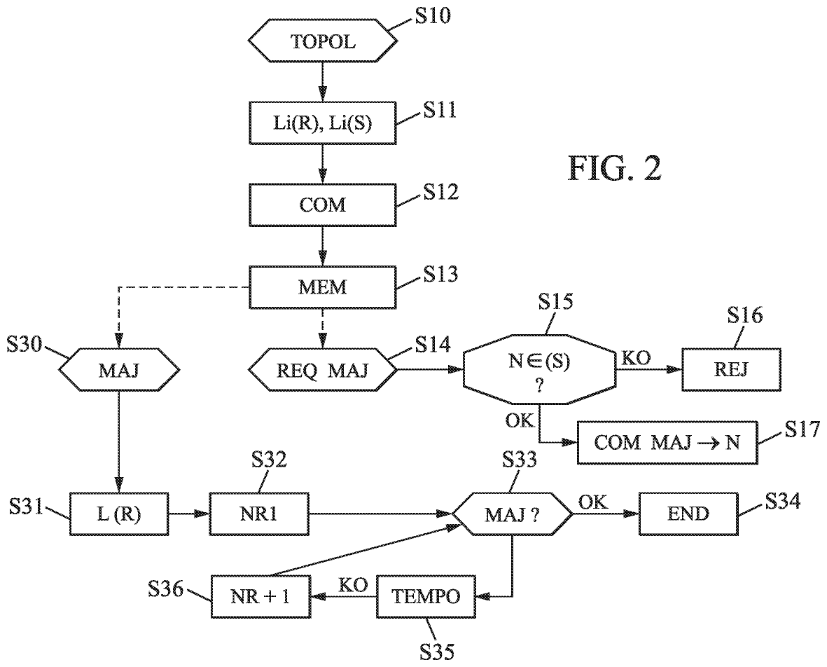

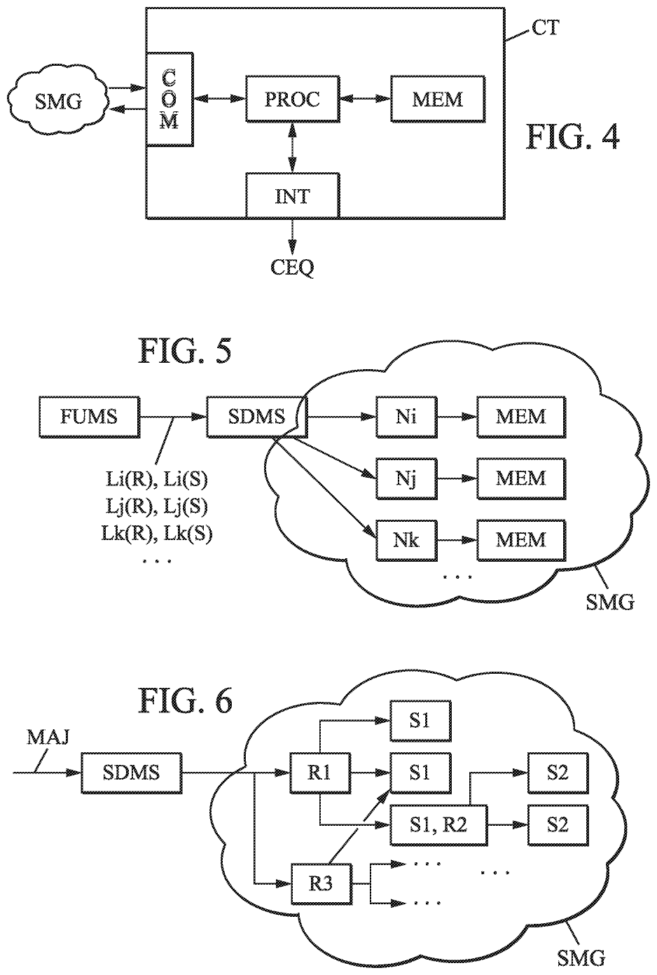

Further, it can be advantageous to provide an ordered list of reference nodes in order to wait for the update data from the first node, and then after a time delay wait for these data from a second node in the list these data, if these data were not provided by the first node on the list, and so on. This implementation is illustrated in FIG. 2, which is now discussed below.

Once the topology of the network is defined during a first step S10, the lists of reference nodes Li(R) and secondary nodes Li(S) can be defined during step S11. In step S12, these lists are communicated to the various nodes of the Smartgrid network so they can be stored in step S13 by each of the nodes, in a sample implementation. It is appropriate to note that as a variant, these lists of nodes can be stored for example by the SMDS root node or by the FUMS update management system.

Next, during a current step S14, a current node of the network receives an update request (where this request typically comprises an identifier for node N of the network). This request may come from the SDMS root node, for example, for a targeted update of a precise node N of the network, and then comprises the identifier of this node N for that purpose. As a variant, this request can be issued directly by this node N, following installation of new hardware connected to this node N, for example.

The list of secondary nodes L(S) of the current node typically comprises the list of identifiers of these secondary nodes, which makes it possible for the current node to compare in step S15 the identifier present in the request to the list of identifiers of secondary nodes. At the outcome of this comparison, if the current node does not find the identifier of the node N in the list, the current node rejects the request in step S16. Otherwise, it sends the update data necessary for the software for the node N in step S17.

In addition or as a variant (typically in the case of a leaf node downstream from the network), a current node can, in step S30, receive an update order sent for example from the FUMS system (via the SDMS root node, for example). In step S31, this current node can consult the list L(R) of the reference nodes thereof and more specifically the respective identifiers thereof in order to send them requests for the update data. Thus in step S32, the identifier of the first reference node NR1 from the list L(R) is used for establishing the first request for update data. If these data are not received in step S33 after time delay S35, then the list is consulted again to send the request to the following node from the list in step S36. If the data are still not received after exhausting identifiers from the list, the current node can again send a request to the first node NR1 and repeat the steps S32, S33, S35 and S36, until receiving the update data in step S34.

Thus, in this implementation it is proposed to define a subset of “reference” nodes in the network in which “up-to-date” software (or firmware) is stored or downloaded in a first step. In a second step, these reference nodes (R Nodes) manage the broadcast of updates to the secondary nodes (S Nodes) via protocols which may comply with the IEC-61850 standard, as disclosed below.

A change of the data model for each equipment unit is therefore proposed comprising two new parameters defined by “data object” type variables according to the IEC-61850 standard:
A list of reference nodes able to update a current node requiring a software update; and
A list of secondary nodes for which a current equipment unit can be a reference node configured for allowing the update for these secondary nodes.

Each equipment unit stores a maintained list of reference nodes and secondary nodes in memory (or can access a remote storing memory). A secondary node can be updated by several reference nodes in order to contribute resiliency to the system. A reference node priority for updating secondary nodes can thus be defined implicitly (according to the order of the reference nodes in the list) or explicitly by other node attributes. These priority nodes can for example advantageously receive a higher cyber security level (anti-intrusion) than other nodes on the list.

More precisely, the IEC 61850-90-16 standard (Part 90-16—“Using IEC 61850 for System Management Purposes”) can be changed for proposing two new variables describing parameters respectively defining the reference nodes and the secondary nodes.

The maximum number of secondary or reference codes can be statically or dynamically configured in the data model for the equipment.

As specified in the IEC 61850-7-2 standard (edition 2.1—“Conditions for Presence Elements”), the objects called “Data Objects” from a logical node class are assigned the conditionality (M/O/C column as shown in the following table). This also makes it possible to define the possibility of having a multiplicity of instances of these data objects (Mmulti, Omulti). The abbreviations M/O/C respectively designate Mandatory, Optional and Conditional. Here, an “optional” and “multiple” (Omulti) type conditionality is chosen as an example, but other implementations are possible. Concretely, this conditionality gives the possibility of instantiating a number of these data objects greater than or equal to zero.

More specifically, in the logical node class relating to firmware management in a given equipment unit (intelligent equipment in the context of a Smartgrid network and called IED for Intelligent Electronic Device), this class is designated “Logical Node LIFH” according to IEC 61850-90-16 (where IFH is IED Firmware Handling), the following can be defined:
The new Data Object variable called “FWUpdRef” (for “Firmware Update Reference Nodes”) with “optional” conditionality “OMulti” (defined by an “Integer Status Setting”) which gives the identifiers for the reference nodes for the software updates for the aforementioned given IED equipment; and
The new Data Object variable called “FWUpdSec” (for “Firmware Update Secondary Nodes”) with “optional” conditionality “OMulti” (defined by an “Integer Status Setting”) and which gives the identifiers for secondary nodes for the updates thereof by transferring the update data via the aforementioned given IED equipment.
The following can then be the declaration table for these variables:

| | | | | |
|---|---|---|---|---|
| Data object name | Common data class | Explanation | T | M/O/C |

| | | | |
|---|---|---|---|
| FWUpdRef | VSG | Referent Nodes | OMulti |
| | | list for IED | |
| FWUpdSec | VSG | Secondary Nodes | OMulti |
| | | list for IED | |

The list of objects can then be defined based on the “Visible String Setting” (Common Data Class) type defined in IEC 61850-7-3, abbreviated VSG.

Each reference node can then authorize and proceed with the update of the software of a secondary node if this secondary node is in the list thereof.

Each secondary node can, in order to update the software thereof, contact an authorized reference node if it is in the reference node list thereof.

FIG. 3 shows a possible implementation of a firmware type software update sequence.

In step S20, a network equipment firmware update management system (FUMS) starts by notifying that a new version is available for some network equipment, for example (or some equipment models, typically IED). A Smartgrid command-control equipment management system, referred to as SDMS, initiates in step S21, subsequent to the step S20, the update deployment process towards one (or more) reference receiving equipment unit(s) R. After retrieving the new version (and acknowledging receipt of this new version in step S22), each reference node R notifies in turn (step S23) the nodes thereof defined as secondary S of the availability of this update. These secondary nodes S are then able to request (step S24) and retrieve (S25) this new software version from the reference node S in order to update the firmware. Next, each equipment unit having done this update can notify the SDMS system in the step S26 of the end of this update in order to record this change therein.

It should be noted that a variant can consist of providing that the secondary nodes query at a set time interval the reference node(s) thereof to verify whether a new update is available.

Generally, the present invention is not limited to the embodiments described above as an example; it extends to other variants.

For example, the situation was presented above in which a current node can have both a list of secondary nodes and a list of reference nodes. However, in a less sophisticated embodiment, only one list of secondary nodes can be provided, where each current node thus propagates the update data to the secondary nodes which are downstream therefrom.

1-15. (canceled)

16. A method for updating software intended to be executed by equipment of an electrical distribution grid, where each equipment unit forms a node of a command-control network communicating with other nodes of this command-control network, the nodes of the command-control network have respective identifiers, the nodes of the command-control network comprise a plurality of reference nodes for respective secondary nodes, a reference node is configured for allowing a software update for at least one secondary node,
Wherein a current node:
obtains first data of the identifier of the at least one secondary node for which the current node is configured for allowing a software update; and
upon receiving a software update request for a secondary node, uses said first data for a software update at least for the secondary node identified in said first data.

17. The method according to claim 16, wherein said current node:
upon receiving a software update request for a given node, where said request comprises the identifier of the given node;
determines whether the identifier of the given node is included among said first data; and
if the identifier of the given node is included among said first data, authorizes a software update for the given node, or otherwise refuses said update.

18. A method for updating software intended to be executed by equipment of an electrical distribution grid, where each equipment unit forms a node of a command-control network communicating with other nodes of this command-control network, the nodes of the command-control network have respective identifiers,
wherein a current node:
obtains second data comprising at least one reference node identifier from the current node; and,
for a software update of the current node:
reads said second data for identifying at least one reference node; and
prepares an update request for the software of the current node,
and wherein said request is intended for the identified reference node and comprises the identifier of the current node.

19. A method for updating software intended to be executed by equipment of an electrical distribution grid, where each equipment unit forms a node of a command-control network communicating with other nodes of this command-control network, the nodes of the command-control network have respective identifiers, the nodes of the command-control network comprise a plurality of reference nodes for respective secondary nodes, a reference node is configured for allowing a software update for at least one secondary node,
wherein a current node:
obtains first data of the identifier of the at least one secondary node for which the current node is configured for allowing a software update; and
upon receiving a software update request for a secondary node, uses said first data for a software update at least for the secondary node identified in said first data.
and wherein a current node:
further obtains second data comprising at least one reference node identifier from the current node; and,
for a software update of the current node:
reads said second data for identifying at least one reference node; and
prepares an update request for the software of the current node,
and wherein said request is intended for the identified reference node and comprises the identifier of the current node.

20. The method according to claim 19, wherein each node stores the first and second data.

21. The method according to claim 16, wherein the first data comprise a list of secondary node identifiers.

22. The method according to claim 18, wherein the second data comprise a list of reference node identifiers.

23. The method according to claim 21, wherein at least one of the lists of secondary node identifiers is declared in the standard IEC 61850 as a multiple instantiation of Data Objects type objects.

24. The method according to claim 23, wherein said multiple instantiation is in the “Logical Node LIFH” logical node class, relating to the management of the software in a current node, according to the IEC 61850 standard.

25. The method according to claim 22, wherein at least one of the lists of reference node identifiers is declared in the standard IEC 61850 as a multiple instantiation of Data Objects type objects.

26. The method according to claim 25, wherein said multiple instantiation is in the “Logical Node LIFH” logical node class, relating to the management of the software in a current node, according to the IEC 61850 standard.

27. The method according to claim 22, wherein the list of reference node identifiers can be ordered and, for a software update of a current node, this current node:
reads said second data for identifying at least one primary reference node from the ordered list;
prepares a first software update request intended for the first identified reference node; and
after a time delay, in case the update is not received, prepares another request intended for the following reference node identified on the ordered list, until receiving said update.

28. The method according to claim 16, wherein a management system for the nodes of the command-control network determines at first, for each node, at least one reference node according to a predetermined topology of the command-controlled network.

29. The method according to claim 16, wherein a management system for the nodes of the command-control network determines at first, for each node, at least one secondary node according to a predetermined topology of the command-controlled network.

30. A system comprising at least:
a first equipment unit comprising a programmed computer circuit for executing the method according to claim 16, as a reference node; and
a second equipment unit comprising a programmed computer circuit for executing a second method as a secondary node, the second method being a method for updating software intended to be executed by equipment of an electrical distribution grid, where each equipment unit forms a node of a command-control network communicating with other nodes of this command-control network, the nodes of the command-control network have respective identifiers,
wherein a current node:
obtains second data comprising at least one reference node identifier from the current node; and,
for a software update of the current node:
reads said second data for identifying at least one reference node; and
prepares an update request for the software of the current node,
and wherein said request is intended for the identified reference node and comprises the identifier of the current node.

31. The system according to claim 30, further comprising a management system for the nodes of the command-control network, said system comprising a computer circuit programmed for executing a method wherein a management system for the nodes of the command-control network determines at first, for each node, at least one reference node according to a predetermined topology of the command-controlled network.

32. A non-transitory computer readable medium on which is stored a computer program comprising instructions for implementing the method according to claim 16, when this program is executed by a processor.

33. Equipment for an electric distribution grid, comprising a programmed computer circuit for executing the method according to claim 16, as a reference node.

34. Equipment for an electric distribution grid, comprising a programmed computer circuit for executing the method according to claim 18 as a secondary node.
